(19) United States
(12) Patent Application Publication
(10) Pub. No.: US 2025/0030128 A1
(43) Pub. Date: Jan. 23, 2025

(54) SEPARATOR FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Hyeonseon CHOI, Yongin-si (KR); Jungseong LEE, Yongin-si (KR); Namju KIM, Yongin-si (KR); Jungran LEE, Yongin-si (KR); Yeonho LEE, Yongin-si (KR); Byongjoon HAN, Yongin-si (KR); Jungjin LEE, Yongin-si (KR)

(21) Appl. No.: 18/632,389

(22) Filed: Apr. 11, 2024

(30) Foreign Application Priority Data
Jul. 12, 2023 (KR) 10-2023-0090560

(51) Int. Cl. H01M 50/489; H01M 50/42; H01M 50/426; H01M 50/434; H01M 50/449

(52) U.S. Cl. CPC H01M 50/489; H01M 50/42; H01M 50/426; H01M 50/434; H01M 50/449

(57) ABSTRACT

A separator for a rechargeable lithium battery, the separator includes a substrate; a heat resistant layer on the substrate; and an adhesive layer on the heat resistant layer, wherein the heat resistant layer includes two types of inorganic particles with different D50 particle diameters, and a salt-based heat resistant binder, and the adhesive layer includes a PVdF first adhesive binder, and a cyano group (—CN)-containing acrylic second adhesive binder.

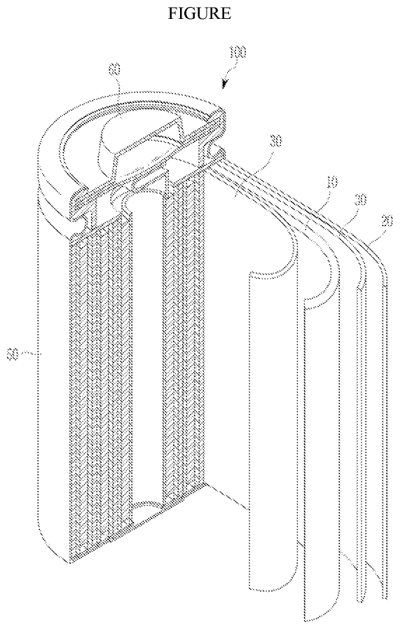

### CROSS-REFERENCE TO RELATED APPLICATION

This application claims priority to and the benefit of Korean Patent Application No. 10-2023-0090560 filed in the Korean Intellectual Property Office on Jul. 12, 2023, the entire contents of which are incorporated herein by reference.

### BACKGROUND

### 1. Field

Embodiments relate to separators for a rechargeable lithium battery and rechargeable lithium batteries including the same are disclosed.

### 2. Description of the Related Art

Recently, with the rapid spread of electronic devices that use batteries, such as mobile phones, laptop computers, and electric vehicles, the demand for rechargeable batteries with high energy density and high capacity is rapidly increasing. Accordingly, research and development to improve the performance of rechargeable lithium batteries is actively underway.

A rechargeable lithium battery may include a positive electrode and a negative electrode including an active material capable of intercalating and deintercalating lithium ions, and an electrolyte, and electrical energy may be produced through oxidation and reduction reactions when lithium ions are intercalated/deintercalated from the positive electrode and negative electrode.

### SUMMARY

The embodiments may be realized by providing a separator for a rechargeable lithium battery, the separator including a substrate; a heat resistant layer on the substrate; and an adhesive layer on the heat resistant layer, wherein the heat resistant layer includes two types of inorganic particles with different D50 particle diameters, and a salt-based heat resistant binder, and the adhesive layer includes a PVdF first adhesive binder, and a cyano group (—CN)-containing acrylic second adhesive binder.

The two types of inorganic particles may each independently include boehmite, silica (SiO₂), alumina (Al₂O₃), titania (TiO₂), clay, BaSO₄, MgO, Mg(OH)₂, or a combination thereof.

The two types of inorganic particles may include first inorganic particles having a D50 particle diameter of greater than or equal to about 1 nm and less than about 200 nm; and second inorganic particles having a D50 particle diameter of greater than or equal to about 200 nm and less than about 500 nm.

The salt-based heat resistant binder may include an acrylic salt-based binder including nitrogen (N).

The salt-based heat resistant binder may include a first structural unit including a structural unit of a (meth)acrylic acid or (meth)acrylate and a structural unit of a (meth)acrylamide; and a second structural unit of a (meth)acrylamidosulfonic acid or a salt thereof.

The structural unit of a (meth)acrylic acid or (meth)acrylate may be represented by Chemical Formula 1, Chemical Formula 2, Chemical Formula 3, or a combination thereof, the structural unit of a (meth)acrylamide may be represented by Chemical Formula 4, and the second structural unit of a (meth)acrylamidosulfonic acid or a salt thereof may be represented by Chemical Formula 5, Chemical Formula 6, Chemical Formula 7, or a combination thereof:

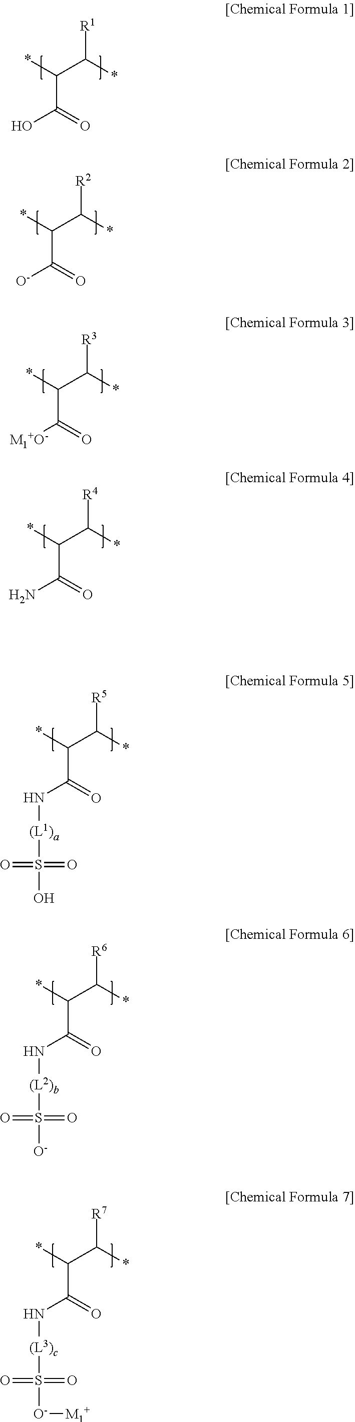

in Chemical Formulas 1 to 7, R¹ to R⁷ may be each independently hydrogen or substituted or unsubstituted C1 to C6 alkyl group; L¹ to L³ may be each independently a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group; M₁ may be an alkali metal; and a, b, and c may be each independently an integer of 0 to 2.

The salt-based heat resistant binder may include poly (acrylic acid-co-acrylamide-co-sodium 2-acrylamido-2-methylpropanesulfonate salt).

The heat resistant layer may further include a swellable binder with a core-shell structure.

The heat resistant layer may include about 70 to about 99 wt % of the two types of inorganic particles entire, and about 1 to about 30 wt % of the heat resistant binder, all wt % being based on a total weight of the heat resistant layer.

The PVdF first adhesive binder may include poly(vinylidene-hexafluoropropylene) (P(VdF-HFP)) including a COOH functional group.

The poly(vinylidene-hexafluoropropylene) (P(VdF-HFP)) including a COOH functional group may have a crystallinity of about 35 to about 50%.

The PVdF first adhesive binder may further include poly(vinylidene-co-hexafluoropropylene) (P(VdF-co-HFP)) not including a COOH functional group.

The poly(vinylidene-co-hexafluoropropylene) (P(VdF-co-HFP)) not including a COOH functional group may have a crystallinity of 10 to 30%.

A weight ratio of the poly(vinylidene-hexafluoropropylene) (P(VdF-HFP)) including a COOH functional group and the poly(vinylidene-co-hexafluoropropylene) (P(VdF-co-HFP)) not including a COOH functional group may be about 1:99 to about 99:1.

The cyano group (—CN)-containing acrylic second adhesive binder may include a third structural unit of a (meth)acrylic acid or (meth)acrylate; a fourth cyano group-containing structural unit; and a fifth structural unit of a (meth)acrylamidosulfonic acid or a salt thereof.

The third structural unit of a (meth)acrylic acid or (meth)acrylate may be represented by Chemical Formula 11, Chemical Formula 12, Chemical Formula 13, or a combination thereof, the fourth cyano group-containing structural unit may be represented by Chemical Formula 14, and the fifth structural unit of a (meth)acrylamidosulfonic acid or the salt thereof may be represented by Chemical Formula 15, Chemical Formula 16, Chemical Formula 17, or a combination thereof:

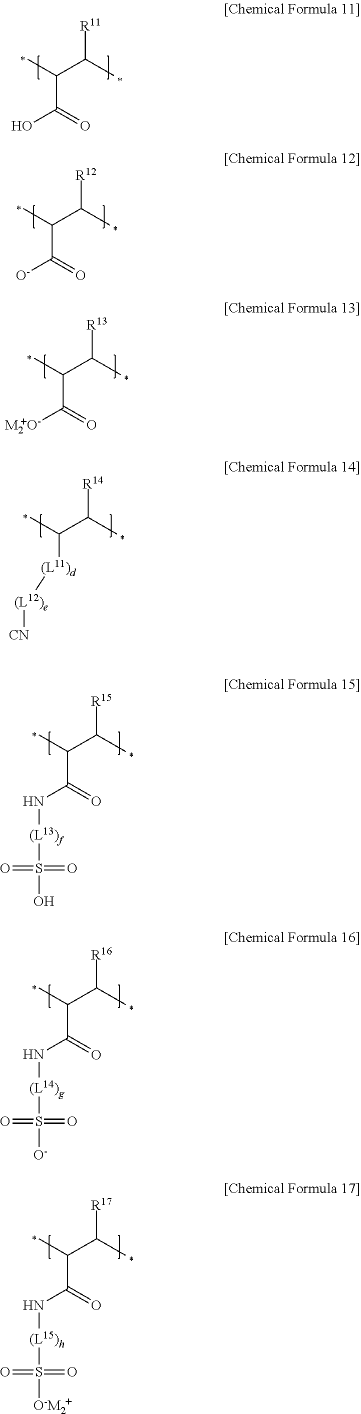

in Chemical Formulae 11 to 17, R¹¹ to R¹⁷ may be each independently hydrogen or a substituted or unsubstituted C1 to C6 alkyl group; L¹¹ and L¹² may be each independently a single bond, a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group; L¹³ to L¹⁵ may be each independently a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group; M₂ may be an alkali metal; and d, e, f, g, and h may be each independently an integer of 0 to 2.

The cyano group (—CN)-containing acrylic second adhesive binder may include poly (acrylic acid-co-acrylonitrile-co-sodium 2-acrylamido-2-methylpropanesulfonate salt).

The adhesive layer may include about 70 to about 99 wt % of the PVdF first adhesive binder, and about 1 to about 30 wt % of the cyano group (—CN)-containing acrylic second adhesive binder, all wt % being based on the total amount of the adhesive layer.

The heat resistant layer and the adhesive layer may be respectively on two opposite surfaces of the substrate.

The embodiments may be realized by providing a rechargeable lithium battery including a positive electrode; a negative electrode; and the separator according to an embodiment between the positive electrode and the negative electrode.

### BRIEF DESCRIPTION OF THE DRAWING

Features will be apparent to those of skill in the art by describing in detail exemplary embodiments with reference to the attached drawing in which:

the FIGURE is schematic view showing a rechargeable lithium battery according to some embodiments.

### DETAILED DESCRIPTION

Example embodiments will now be described more fully hereinafter with reference to the accompanying drawing; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figure, the dimensions of layers and regions may be exaggerated for clarity of illustration. It will also be understood that when a layer or element is referred to as being “on” another layer or element, it can be directly on the other layer or element, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, when specific definition is not otherwise provided, the singular may also include the plural. In addition, unless otherwise specified, “A or B” may mean “including A, including B, or including A and B.”

As used herein, “combination thereof” may mean a mixture of constituents, a stack, a composite, a copolymer, an alloy, a blend, and a reaction product.

As used herein, when a definition is not otherwise provided, a particle diameter may be an average particle diameter. This average particle diameter means an average particle diameter (D50), which is a diameter of particles with a cumulative volume of 50 volume % in the particle size distribution. The average particle size (D50) can be measured by methods well known to those skilled in the art, for example, by measuring with a particle size analyzer, a transmission electron microscope or scanning electron microscope, or a scanning electron microscope. Alternatively, a dynamic light-scattering measurement device is used to perform a data analysis, and the number of particles is counted for each particle size range. From this, the average particle diameter (D50) value may be easily obtained through a calculation. A laser diffraction method may also be used. When measuring by laser diffraction, more specifically, the particles to be measured are dispersed in a dispersion medium and then introduced into a commercially available laser diffraction particle size measuring device (e.g., MT 3000 available from Microtrac, Ltd.) using ultrasonic waves at about 28 kHz, and after irradiation with an output of 60 W, the average particle size (D50) based on 50% of the particle size distribution in the measuring device can be calculated.

As used herein, when specific definition is not otherwise provided, “substituted” refers to replacement of at least one hydrogen atom by a substituent selected from a halogen atom (F, Cl, Br, or I), a hydroxy group, a C1 to C20 alkoxy group, a nitro group, a cyano group, an amine group, an imino group, an azido group, an amidino group, a hydrazino group, a hydrazono group, a carbonyl group, a carbamyl group, a thiol group, an ester group, an ether group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C30 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, or a combination thereof. As used herein, hydrogen substitution (-H) may include deuterium substitution (-D) or tritium substitution (-T). For example, any hydrogen in any compound described herein may be protium, deuterium, or tritium (e.g., based on natural or artificial substitution).

As used herein, when specific definition is not otherwise provided, “heterocycloalkyl group”, “heterocycloalkenyl group”, “heterocycloalkynyl group” and “heterocycloalkylene group” refer to a cyclic compound such as cycloalkyl, cycloalkenyl, cycloalkynyl, and cycloalkylene including at least one heteroatom of N, O, S, or P.

As used herein, when specific definition is not otherwise provided, “hetero” refers to inclusion of at least one heteroatom of N, O, S, and P in chemical formulae.

As used herein, when a definition is not otherwise provided, “*” refers to a linking part between the same or different atoms, or chemical formulae.

As used herein, a weight average molecular weight (Mw) may be a value measured using gel permeation chromatography (GPC).

### Separator

Some embodiments may provide a separator for a rechargeable lithium battery including a substrate; a heat resistant layer on the substrate; and an adhesive layer on the heat resistant layer. In an implementation, the heat resistant layer may include, e.g., two types of inorganic particles with different D50 particle diameters, and a salt-based heat resistant binder. In an implementation, the adhesive layer may include, e.g., a PVdF first adhesive binder, and a cyano group (—CN)-containing acrylic second adhesive binder.

The separator according to some embodiments may help simultaneously secure heat resistance and adhesion, thereby improving cycle-life characteristics of a rechargeable lithium battery at ambient temperature and high temperature.

Hereinafter, the separator of the embodiment will be described in more detail with reference to the FIGURE.

### Heat Resistant Layer

The heat resistant layer may include, e.g., two types of inorganic particles with different particle sizes and a salt-based heat resistant binder.

In an implementation, a loading amount of the heat resistant layer may be the same, compared to the case where only one type of inorganic particle is used, two types of inorganic particles with different D50 particle sizes may be used, and the coating density of the heat resistant layer may be increased.

### Inorganic Particles

The two types of inorganic particles may independently be highly heat-resistant, and may include ceramics.

The two types of inorganic particles may each independently include, e.g.,. boehmite, silica SiO₂, alumina (Al₂O₃), titania (TiO₂), clay, BaSO₄, MgO, Mg(OH)₂, or a combination thereof. In an implementation, the two types of inorganic particles with different D50 particle diameters may each be boehmite, which makes it easy to control the D50 particle diameter and shape.

In an implementation, the two types of inorganic particles may include, e.g., first inorganic particles having a D50 particle diameter of greater than or equal to about 1 nm and less than about 200 nm, greater than or equal to about 10 nm and less than or equal to about 180 nm, or greater than or equal to about 50 nm and less than or equal to about 150 nm; and a second inorganic particle having a D50 particle diameter of greater than or equal to about 200 nm and less than about 500 nm, greater than or equal to about 220nm and less than or equal to about 400 nm, or greater than or equal to about 250 nm and less than or equal to about 350 nm.

In an implementation, the shape of the two types of inorganic particles may be cubic. In an implementation, compared to inorganic particles of other shapes, it may be advantageous to increase the coating density of the heat resistant layer.

### Salt-Based Heat Resistant Binder

The salt-based heat resistant binder may be a binder with high heat resistance and may include an acrylic salt-based binder including nitrogen (N).

The salt-based heat resistant binder may include a first structural unit including a structural unit of a (meth)acrylic acid or a (meth)acrylate and a structural unit of a (meth)acrylamide; and a second structural unit of a (meth)acrylamidosulfonic acid or a salt thereof.

The structural unit of a (meth)acrylic acid or (meth)acrylate may be represented by, e.g., Chemical Formula 1, Chemical Formula 2, Chemical Formula 3, or a combination thereof.

The structural unit of a (meth)acrylamide may be represented by, e.g., Chemical Formula 4.

The second structural unit of a (meth)acrylamidosulfonic acid or the salt thereof may be represented by, e.g., Chemical Formula 5, Chemical Formula 6, Chemical Formula 7, or a combination thereof.

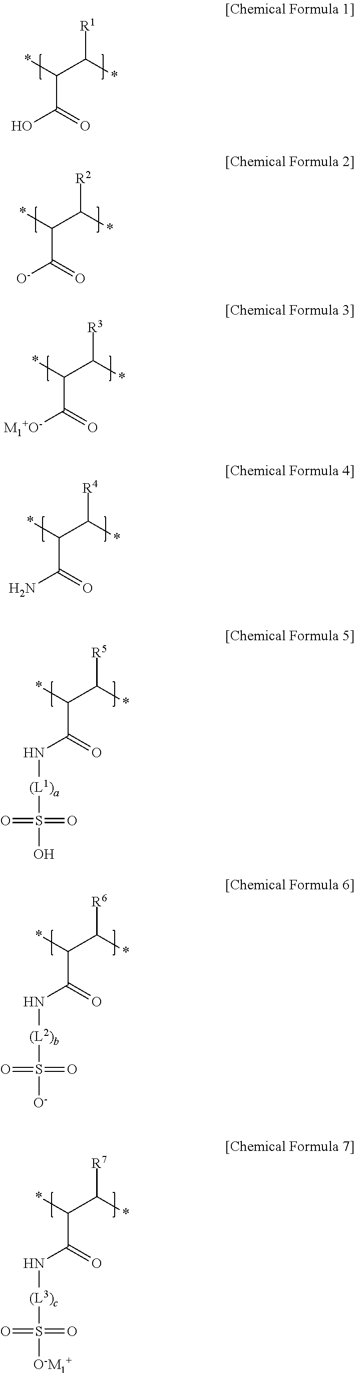

The descriptions of Chemical Formulae 1 to 7 are as follows:

R¹ to R⁷ may each independently be, e.g., hydrogen or a substituted or unsubstituted C1 to C6 alkyl group. In an implementation, R¹ to R⁷ may each be hydrogen.

L¹ to L³ may each independently be, e.g., a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group. In an implementation, L¹ to L³ may each be *—C(CH₃)₂—CH₂—*.

M₁ may be, e.g., an alkali metal. In an implementation alkali metal may be lithium, sodium, potassium, rubidium, or cesium, e.g., lithium or sodium.

a, b, and c may each independently be, e.g., an integer of 0 to 2. In an implementation, a, b, and c may each be 1.

The structural unit of a (meth)acrylic acid or (meth)acrylate may include, respectively, or together, the structural unit represented by the Chemical Formula 1 and the structural unit represented by the Chemical Formula 2. In the latter case, the structural unit of a (meth)acrylic acid or (meth)acrylate may include the structural unit represented by the Chemical Formula 1 and the structural unit represented by the Chemical Formula 2 in a mole ratio of about 1:10 to about 2:1, about 1:5 to about 1:1, or about 1:1 to about 1:3.

The structural unit of a (meth)acrylamidosulfonic acid or the salt thereof may include, respectively, or together, the structural unit represented by the Chemical Formula 5 and the structural unit represented by the Chemical Formula 7. In the latter case, the structural unit derived from (meth)acrylamidosulfonic acid or the salt thereof may include the structural unit represented by the Chemical Formula 5 and the structural unit represented by the Chemical Formula 7 in a mole ratio of about 1:10 to about 2:1, about 1:5 to about 1:1, or about 1:1 to about 1:3.

Based on 100 mol % of the salt-based heat resistant binder, the first structural unit may be included in an amount of greater than or equal to about 90 mol % and less than about 100 mol %, or greater than or equal to about 95 mol % and less than about 100 mol %; and the second structural unit may be included in an amount of greater than about 0 mol % and less than or equal to about 10 mol %, or greater than about 0 mol % and less than or equal to about 5 mol %.

In an implementation, the salt-based heat resistant binder may include a moiety represented by Chemical Formula 8.

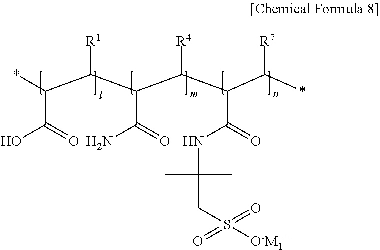

In Chemical Formula 8, R¹, R⁴, and R⁷ may each independently be, e.g., hydrogen or a substituted or unsubstituted C1 to C6 alkyl group. M₁ may be, e.g., an alkali metal. The alkali metal may be lithium, sodium, potassium, rubidium, or cesium, e.g. lithium or sodium.

l, m, and n mean a mole ratio of each unit, e.g., 0.9≤(l+m)<1, and 0<n≤0.1, and l+m+n=1. In an implementation, 0≤l≤0.4, 0.55≤m≤0.95, and 0≤n≤0.1. In an implementation, 0<l≤0.05, 0.9≤m≤0.95, and 0<n≤0.05.

The salt-based heat resistant binder represented by Chemical Formula 8 may include, e.g., a poly (acrylic acid-co-acrylamide-co-sodium 2-acrylamido-2-methylpropanesulfonate salt).

The salt-based heat resistant binder may be prepared by various suitable methods such as emulsion polymerization, suspension polymerization, bulk polymerization, solution polymerization, or bulk polymerization.

### Swellable Binder with Core-Shell Structure

In an implementation, the heat resistant layer may further include a swellable binder with a core-shell structure.

The swellable binder with the core-shell structure may be a binder that includes a structural unit of a vinyl aromatic compound, a structural unit of an aliphatic acrylate compound, and a structural unit of a phosphonate acrylate compound.

The swellable binder with the core-shell structure may have a glass transition temperature (Tg) of about 60 to about 120° C., and may expand about 2 to about 1,000 times compared to its initial volume when impregnated with an electrolyte solution.

In an implementation, the swellable binder with the core-shell structure may be further included, and the weight ratio of the salt-based heat resistant binder and the swellable binder with the core-shell structure may be about 1:99 to about 99:1, e.g., about 50:50 to about 99:1, or about 70:30 to about 99:1.

### Composition of Heat Resistant Layer

The heat resistant layer may include about 1 to about 30 wt %, about 1 to about 20 wt %, or about 1 to about 10 wt % of a sum of the two types of inorganic particles, based on a total weight of the heat resistant layer.

The heat resistant layer may include about 1 to about 30 wt %, about 1 to about 20 wt %, or about 1 to about 10 wt % of the heat resistant binder, based on the total weight of the heat resistant layer.

Within the above ranges, the separator of some embodiments may exhibit excellent heat resistance.

### Thickness of Heat Resistant Layer

The thickness of heat resistant layer may be about 0.5 to 2.5 μm, about 1 to about 2 μm, or about 1.5 to about 2 μm.

Within the above ranges, the separator of some embodiments may exhibit excellent heat resistance.

### Adhesive Layer

The adhesive layer may include, e.g., a PVdF first adhesive binder, and a cyano group (—CN)-containing acrylic second adhesive binder.

### PVdF First Adhesive Binder

The adhesive layer may include a PVdF first adhesive binder that has excellent adhesion when wetting and/or drying.

In an implementation, the PVdF first adhesive binder may include a PVdF 1-1 adhesive binder (e.g., PVdF first first adhesive binder) having excellent adhesion when wetting.

The PVdF 1-1 adhesive binder may include poly(vinylidene-hexafluoropropylene) (P(VdF-HFP)) including a COOH functional group.

The PVdF 1-1 adhesive binder may have a crystallinity of about 35 to about 50%. In this range, adhesion when wetting may be improved.

The PVdF 1-1 adhesive binder may have a weight average molecular weight (Mw) of about 1,000,000 to about 2,000,000 g/mol measured according to the GPC method.

The PVdF 1-1 adhesive binder may have a glass transition temperature (Tg) of about −20 to about −40° C.

The PVdF 1-1 adhesive binder may have a melting point of about 150 to about 160° C.

In an implementation, the PVdF first adhesive binder may include (e.g., may further include) a PVdF 1-2 adhesive binder (e.g., PVdF second first adhesive binder) having excellent adhesion when drying.

The PVdF 1-2 adhesive binder may include poly(vinylidene-co-hexafluoropropylene) (P(VdF-co-HFP)) which does not include a COOH functional group.

The PVdF 1-2 adhesive binder may have a crystallinity of about 10 to about 30%. In this range, adhesion when drying may be highly improved.

The PVdF 1-2 adhesive binder may have a weight average molecular weight (Mw) of about 1,000,000 to about 2,000,000 g/mol measured according to the GPC method.

The PVdF 1-2 adhesive binder may have a glass transition temperature (Tg) of about −20 to about −40° C.

In some embodiments, the PVdF 1-2 adhesive binder may have a melting point of about 150 to about 160° C.

In an implementation, a weight ratio of the PVdF 1-1 adhesive binder and the PVdF 1-2 adhesive binder may be about 1:99 to about 99:1, about 30:70 to about 70:30, or about 40:60 to about 60:40.

### Cyano Group (—CN)-Containing Acrylic Second Adhesive Binder

The adhesive layer may include the cyano group (—CN)-containing acrylic second adhesive binder, which may have excellent adhesion and oxidation resistance.

The cyano group (—CN)-containing acrylic second adhesive binder may include, e.g., a third structural unit of a (meth)acrylic acid or (meth)acrylate; a fourth cyano group-containing structural unit; and a fifth structural unit of a (meth)acrylamidosulfonic acid or a salt thereof.

The third structural unit of a (meth)acrylic acid or (meth)acrylate may be represented by, e.g., Chemical Formula 11, Chemical Formula 12, Chemical Formula 13, or a combination thereof.

The fourth cyano group-containing structural unit may be represented by, e.g., Chemical Formula 14.

The fifth structural unit of a (meth)acrylamidosulfonic acid or salt thereof may be represented by, e.g., Chemical Formula 15, Chemical Formula 16, Chemical Formula 17, or a combination thereof.

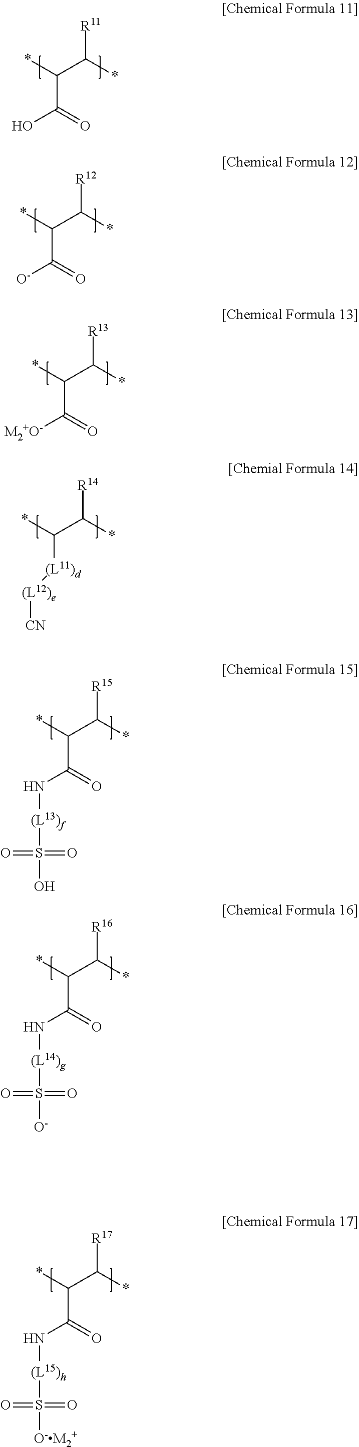

The descriptions of Chemical Formulae 11 to 17 are as follows:

R¹¹ to R¹⁷ may each independently be, e.g., hydrogen or a substituted or unsubstituted C1 to C6 alkyl group. In an implementation, R¹¹ to R¹⁷ may each be hydrogen.

L¹¹ and L¹² may each independently be, e.g., a single bond, a substituted or unsubstituted C1 to C10 alkylene group, a substituted or unsubstituted C3 to C20cycloalkylene group, a substituted or unsubstituted C6 to C20 arylene group, or a substituted or unsubstituted C3 to C20 heterocyclic group. In an implementation, L¹¹ and L¹² may each be a single bond.

L¹³ to L¹⁵ may each independently be, e.g., a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group. In an implementation, L¹³ to L¹⁵ may each be *—C(CH₃)₂—CH₂—*.

M₂ may be, e.g., alkali metal. The alkali metal may be lithium, sodium, potassium, rubidium, or cesium, e.g., lithium or sodium.

d, e, f, g, and h may each independently be, e.g., an integer of 0 to 2. In an implementation, d, e, f, g, and h may each be 1.

The third structural unit of a (meth)acrylic acid or (meth)acrylate may include, respectively, or together, the structural unit represented by Chemical Formula 11 and the structural unit represented by Chemical Formula 12. In the latter case, the structural unit of a (meth)acrylic acid or (meth)acrylate may include the structural unit represented by Chemical Formula 11 and the structural unit represented by Chemical Formula 12 in a mole ratio of about 1:10 to about 2:1, about 1:5 to about 1:1, or about 1:1 to about 1:3.

The fifth structural unit of a (meth)acrylic acid or (meth)acrylate may include, respectively, or together, the structural unit represented by Chemical Formula 15 and the structural unit represented by Chemical Formula 17. In the latter case, the structural unit of a (meth)acrylic acid or (meth)acrylate may include the structural unit represented by Chemical Formula 15 and the structural unit represented by Chemical Formula 17 in a mole ratio of about 1:10 to about 2:1, about 1:5 to about 1:1, or about 1:1 to about 1:3.

Based on 100 mol % of the cyano group (—CN)-containing acrylic second adhesive binder, the third structural unit may be included in an amount of greater than or equal to about 10 mol % and less than or equal to about 70 mol %, greater than or equal to about 30 mol % and less than or equal to about 60 mol %, or greater than or equal to about 40 mol % and less than or equal to about 50 mol %; the fourth structural unit may be included in an amount of greater than or equal to about 30 mol % and less than or equal to about 85 mol %, greater than or equal to about 40 mol % and less than or equal to about 70 mol %, or greater than or equal to about 45 mol % and less than or equal to about 55 mol %; and the fifth structural unit may be included in an amount of greater than or equal to about 0.1 mol % and less than or equal to about 20 mol %, greater than or equal to about 0.5 mol % and less than or equal to about 15 mol %, or greater than or equal to about 1 mol % and less than or equal to about 10 mol %.

In an implementation, the cyano group (—CN)-containing acrylic second adhesive binder may be represented by, e.g., Chemical Formula 18.

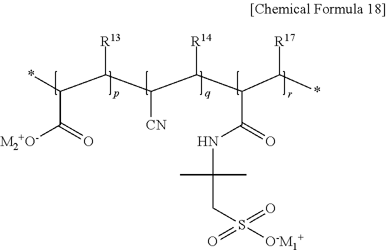

In Chemical Formula 18, R¹³, R¹⁴, and R¹⁷ may each independently be, e.g.,

hydrogen or a substituted or unsubstituted C1 to C6 alkyl group. M2 may be, e.g., an alkali metal. The alkali metal may be lithium, sodium, potassium, rubidium, or cesium, e.g., lithium or sodium.

p, q, and r mean a mole ratio of each unit, e.g., 0.1≤p≤0.7, 0.3≤m≤0.85, and 0.001≤n≤0.2. In an implementation, 0.3≤p≤0.6, 0.4≤q≤0.7, and 0.005≤r≤0.15. In an implementation, 0.4≤p≤0.5, 0.45≤q≤0.55, and 0.01≤r≤0.1.

In an implementation, the cyano group (—CN)-containing acrylic second

adhesive binder represented by Chemical Formula 18 may include, e.g., poly(acrylic acid-co-acrylonitrile-co-sodium 2-acrylamido-2-methylpropanesulfonate salt).

The cyano group (—CN)-containing acrylic second adhesive binder may be prepared by various suitable methods such as emulsion polymerization, suspension polymerization, bulk polymerization, solution polymerization, or bulk polymerization.

### Composition of Adhesive Layer

The adhesive layer may include about 70 to about 99 wt %, about 80 to about 99 wt %, or about 90 to about 99 wt % of the PVdF first adhesive binder based on a total weight of the adhesive layer.

The adhesive layer may include about 1 to about 30 wt %, about 1 to about 20 wt %, or about 1 to about 10 wt % of the cyano group (—CN)-containing acrylic second adhesive binder based on a total weight of the adhesive layer.

Within the above ranges, the separator of some embodiments may exhibit excellent adhesion.

### Thickness of Adhesive Layer

A thickness of the adhesive layer may be about 0.1 to about 1.5 μm, about 0.3 to about 1.2 μm, or about 0.5 to about 1 μm.

Within the above ranges, the separator of some embodiments may exhibit excellent adhesion.

### Single-Surface Coating or Both-Surfaces Coating

In an implementation, the heat resistant layer and the adhesive layer may each

independently be coated on one surface or both (e.g., two opposite) surfaces of the substrate.

In an implementation, both the heat resistant layer and the adhesive layer may be on both surfaces of the substrate. In this case, it may be advantageous to simultaneously secure the heat resistance and adhesion of the separator.

### Substrate

The substrate may be a porous substrate.

The porous substrate may be a polymer film formed of a polymer, or a copolymer or mixture of two or more of polyolefin, e.g., polyethylene or polypropylene, a polyester such as polyethyleneterephthalate, or polybutyleneterephthalate, polyacetal, polyamide, polyimide, polycarbonate, polyether ketone, polyaryl ether ketone, polyether imide, polyamideimide, polybenzimidazole, polyether sulfone, polyphenylene oxide, a cyclic olefin copolymer, polyphenylene sulfide, polyethylene naphthalate, a glass fiber, TEFLON (tetrafluoroethylene), or polytetrafluoroethylene.

In an implementation, the porous substrate may be a polyolefin substrate including polyolefin, and the polyolefin substrate may have an excellent shutdown function, which may help contribute to improving the safety of the battery. The polyolefin substrate may include, e.g.,, a polyethylene single film, a polypropylene single film, a polyethylene/polypropylene double film, a polypropylene/polyethylene/polypropylene triple film, or a polyethylene/polypropylene/polyethylene triple film. In an implementation, the polyolefin resin may include a non-olefin resin in addition to an olefin resin, or may include a copolymer of olefin and non-olefin monomer.

The porous substrate may have a thickness of about 1 μm to about 40 μm, for example about 1 μm to about 30 μm, about 1 μm to about 20 μm, about 5 μm to about 20 μm, about 5 μm to about 15 μm, or about 5 μm to about 10 μm.

### Manufacturing Method

A separator for a rechargeable lithium battery according to some embodiments may be manufactured by various suitable methods. In an implementation, a separator for a rechargeable lithium battery may be formed by applying a composition for forming each layer to one or both surfaces of a porous substrate and then drying it.

The coating may include, e.g., spin coating, dip coating, bar coating, die coating, slit coating, roll coating, inkjet printing, or the like.

The drying may be, e.g., performed through natural drying, drying with warm air, hot air, or low humidity air, vacuum-drying, or radiation of a far-infrared ray, an electron beam, or the like. The drying process may be performed at a temperature of, e.g., about 25° C. to about 120° C.

The separator for a rechargeable lithium battery may be manufactured by lamination, coextrusion, or the like in addition to the above method.

### Rechargeable Lithium Battery

Some embodiments provide a rechargeable lithium battery including the aforementioned separator for a rechargeable lithium battery.

### Positive Electrode Active Material

The positive electrode active material may be a compound (lithiated intercalation compound) capable of intercalating and deintercalating lithium. In an implementation, one or more types of composite oxides of lithium and a metal selected from cobalt, manganese, nickel, and combinations thereof may be used.

The composite oxide may be a lithium transition metal composite oxide, and may include, e.g., lithium nickel oxide, lithium cobalt oxide, lithium manganese oxide, a lithium iron phosphate compound, cobalt-free lithium nickel-manganese oxide, or a combination thereof.

In an implementation, a compound represented by any of the following chemical formulae may be used. LiₐA_{1-b}X_{b}O_{2-c}D′_{c} (0.90≤a≤1.8, 0≤b≤0.5, 0≤c≤0.05); LiₐMn_{2-b}X_{b}O_{4-c}D′_{c} (0.90≤a≤1.8, 0≤b≤0.5, 0≤c≤0.05); LiₐNi_{1-b-c}Co_{b}X_{c}O_{2-α}D′_{α} (0.90≤a≤1.8, 0≤b≤0.5, 0≤c≤0.5, 0<α<2); LiₐNi_{1-b-c}Mn_{b}X_{c}O_{2-α}D′_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above chemical formulas, A may be Ni, Co, Mn, or a combination thereof; X may be Al, Ni, Co, Mn, Cr, Fe, Mg, Sr, V, a rare earth element, or a combination thereof; D′ may be O, F, S, P, or a combination thereof; G may be Al, Cr, Mn, Fe, Mg, La, Ce, Sr, V, or a combination thereof; and L1 may be Mn, Al, or a combination thereof.

### Positive Electrode

The positive electrode for a rechargeable lithium battery may include a current collector and a positive electrode active material layer on the current collector. The positive electrode active material layer may include a positive electrode active material and may further include a binder or a conductive material.

In an implementation, the positive electrode may further include an additive that can function as a sacrificial positive electrode.

A content of the positive electrode active material may be about 90 wt % to about 99.5 wt %, and a content of the binder and the conductive material may be about 0.5 wt % to about 5 wt %, respectively based on 100 wt % of the positive electrode active material layer.

The binder may attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like.

The conductive material may impart conductivity (e.g., electrical conductivity) to the electrode. A suitable material that does not cause chemical change (e.g., does not cause an undesirable chemical change in the rechargeable lithium battery) and conducts electrons may be used in the battery. Examples of the conductive material may include a carbon material such as natural graphite, artificial graphite, carbon black, acetylene black, ketjen black, a carbon fiber, a carbon nanofiber, or carbon nanotube; a metal material including copper, nickel, aluminum, silver, or the like, in a form of a metal powder or a metal fiber; a conductive polymer such as a polyphenylene derivative; or a mixture thereof.

In an implementation, Al may be used as the current collector.

### Negative Electrode Active Material

The negative electrode active material may be a material that reversibly intercalates/deintercalates lithium ions, a lithium metal, a lithium metal alloy, a material capable of doping and dedoping lithium, or a transition metal oxide.

The material that reversibly intercalates/deintercalates lithium ions may include a carbon negative electrode active material, e.g., crystalline carbon, amorphous carbon, or a combination thereof. The crystalline carbon may be graphite such as irregular, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy may include lithium and a metal, e.g., Na, K, Rb, Cs, Fr, Be, Mg, Ca, Sr, Si, Sb, Pb, In, Zn, Ba, Ra, Ge, Al, or Sn.

The material capable of doping/dedoping lithium may be a Si negative electrode active material or a Sn negative electrode active material. The Si negative electrode active material may include silicon, a silicon-carbon composite, SiOₓ (0<x<2), a Si—Q alloy (wherein Q is selected from an alkali metal, an alkaline-earth metal, a Group 13 element, a Group 14 element (excluding Si), a Group 15 element, a Group 16 element, a transition metal, a rare earth element, and a combination thereof). The Sn negative electrode active material may include Sn, SnO₂, a Sn alloy, or a combination thereof.

The silicon-carbon composite may be a composite of silicon and amorphous carbon. In an implementation, the silicon-carbon composite may be in a form of silicon particles and amorphous carbon coated on the surface of the silicon particles. In an implementation, the silicon-carbon composite may include a secondary particle (core) in which primary silicon particles are assembled, and an amorphous carbon coating layer (shell) on the surface of the secondary particle. The amorphous carbon may also be between the primary silicon particles, and, e.g., the primary silicon particles may be coated with the amorphous carbon. The secondary particle may exist dispersed in an amorphous carbon matrix.

The silicon-carbon composite may further include crystalline carbon. In an implementation, the silicon-carbon composite may include a core including crystalline carbon and silicon particles and an amorphous carbon coating layer on a surface of the core.

In an implementation, the Si negative electrode active material or the Sn negative electrode active material may be used in combination with a carbon negative electrode active material.

### Negative Electrode

A negative electrode for a rechargeable lithium battery may include a current collector and a negative electrode active material layer on the current collector. The negative electrode active material layer may include a negative electrode active material and may further include a binder or a conductive material.

In an implementation, the negative electrode active material layer may include about 90 wt % to about 99 wt % of the negative electrode active material, about 0.5 wt % to about 5 wt % of the binder, and about 0.5 wt % to about 5 wt % of the conductive material.

The binder may attach the negative electrode active material particles well to each other and also to attach the negative electrode active material well to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

In an implementation, an aqueous binder may be used as the negative electrode binder, and it may further include a cellulose compound capable of imparting viscosity (e.g., a thickener). The cellulose compound may include, e.g., carboxylmethyl cellulose, hydroxypropylmethyl cellulose, methyl cellulose, or alkali metal salts thereof. The alkali metal may be Na, K, or Li.

The dry binder may be a polymer material capable of being fiberized, and may include, e.g., polytetrafluoroethylene, polyvinylidene fluoride, polyvinylidene fluoride-hexafluoropropylene copolymer, polyethylene oxide, or a combination thereof.

The conductive material may provide electrode conductivity, and a suitable electrically conductive material may be used as a conductive material unless it causes a chemical change. Examples of the conductive material may include a carbon material such as natural graphite, artificial graphite, carbon black, acetylene black, ketjen black, a carbon fiber, a carbon nanofiber, a carbon nanotube, and the like; a metal material such as copper, nickel, aluminum silver, and the like in a form of a metal powder or a metal fiber; a conductive polymer such as a polyphenylene derivative; or a mixture thereof.

The negative electrode current collector may include a copper foil, a nickel foil, a stainless steel foil, a titanium foil, a nickel foam, a copper foam, a polymer substrate coated with a conductive metal, or a combination thereof.

### Electrolyte Solution

The electrolyte solution for a rechargeable lithium battery may include a non-aqueous organic solvent and a lithium salt.

The non-aqueous organic solvent may be a medium for transmitting ions taking part in the electrochemical reaction of a battery.

The non-aqueous organic solvent may include, e.g., a carbonate, ester, ether, ketone, alcohol solvent, aprotic solvent, or a combination thereof.

The carbonate solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like. The ester solvent may include methyl acetate, ethyl acetate, n-propyl acetate, dimethylacetate, methylpropionate, ethylpropionate, decanolide, mevalonolactone, valerolactone, caprolactone, or the like. The ether solvent may include dibutyl ether, tetraglyme, diglyme, dimethoxyethane, 2-methyltetrahydrofuran, 2,5-dimethyltetrahydrofuran, or tetrahydrofuran. The ketone solvent may include cyclohexanone. The alcohol solvent may include ethyl alcohol, isopropyl alcohol, or the like. The aprotic solvent may include nitriles such as R—CN (wherein R is a C2 to C20 linear, branched, or cyclic hydrocarbon group, a double bond, an aromatic ring, or an ether group), amides such as dimethylformamide, dioxolanes such as 1,3-dioxolane or 1,4-dioxolane, sulfolanes, or the like.

The non-aqueous organic solvent may be used alone or in combination of two or more.

In an implementation, a carbonate solvent may be used, and cyclic carbonate and chain carbonate can be mixed and used, and cyclic carbonate and chain carbonate can be mixed at a volume ratio of about 1:1 to about 1:9.

The lithium salt dissolved in the organic solvent may supply lithium ions in a battery, may enable a basic operation of a rechargeable lithium battery, and may improve transportation of the lithium ions between positive and negative electrodes. Examples of a lithium salt may include LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide (LiFSI), LiC₄F₉SO₃, LiN(CₓF₂ₓ₊₁SO₂)(C_{y}F_{2y+1}SO₂) (x and y are integers from 1 to 20), lithium trifluoromethane sulfonate, lithium tetrafluoroethanesulfonate, lithium difluorobis(oxalato)phosphate, (LiDFOB), and lithium bis(oxalato)borate (LiBOB).

### Rechargeable Lithium Battery

The rechargeable lithium battery may be classified into cylindrical, prismatic, pouch, or coin-type batteries, and the like depending on their shape. The FIGURE is schematic view illustrating a rechargeable lithium battery according to some embodiments and shows a cylindrical battery. Referring to the FIGURE, the rechargeable lithium battery 100 may include an electrode assembly including a separator 30 between a positive electrode 10 and a negative electrode 20, and a case 50 in which the electrode assembly is housed. The positive electrode 10, the negative electrode 20, and the separator 30 may be impregnated with an electrolyte, and the case 50 may be sealed with a seal 60.

The rechargeable lithium battery according to some embodiments may be applied to automobiles, mobile phones, or various types of electrical devices.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### EXAMPLES

### Example 1

### (1) Preparation of Salt-Based Heat Resistant Binder

In a 10 L four-necked flask equipped with a stirrer, a thermometer, and a cooling tube, after adding distilled water (6,361 g), acrylic acid (72.06 g, 1.0 mol), acrylamide (604.1 g, 8.5 mol), potassium persulfate (2.7 g, 0.01 mol), 2-acrylamido-2-methylpropanesulfonic acid (103.6 g, 0.5 mol), and 5 N sodium hydroxide aqueous solution (1.05 equivalents based on a total amount of 2-acrylamido-2-methylpropanesulfonic acid), an operation of reducing an internal pressure to 10 mmHg with diaphragm pump and returning the internal pressure to normal pressure with nitrogen, was repeated three times.

While controlling the temperature of reaction solution so as to be stable between 65° C. to 70° C., the reaction was conducted for 12 hours. After cooling to ambient temperature, the pH of the reaction solution is adjusted to 7 to 8 using a 25% aqueous ammonia solution.

The poly(acrylic acid-co-acrylamide-co-sodium 2-acrylamido-2-methylpropanesulfonate salt) was prepared in this manner. Herein, the mole ratio of the structural unit of acrylic acid, the structural unit of acrylamide, and the structural unit of 2-acrylamido-2-methylpropanesulfonic acid was 10:85:5. About 10 mL of the reaction solution (reaction product) was taken and the measurement result of the non-volatile component is 9.5% (theoretical value: 10%).

### (2) Preparation of Composition for Forming Heat Resistant Layer

Boehmite (each from Nabaltec, Germany) with different particle sizes were pulverized for 2 hours through a bead mill, and the D50 particle sizes were pulverized to 100 nm (first inorganic particle) and 300 nm (second inorganic particle), respectively to obtain 40 wt % of inorganic dispersion. A weight ratio of the first inorganic particles to the second inorganic particles was 5:95.

Subsequently, the inorganic dispersion was mixed with the heat resistant binder to include 95 wt % of the boehmite (total inorganic particles) and 5 wt % of the heat resistant binder based on a solid content, and a composition for forming a heat resistant layer was prepared by adding water thereto to adjust a total solid content to 25 wt %.

### (3) Preparation of Cyano Group (—CN)-Containing Acrylic Second Adhesive Binder

In a 3 L four-necked flask equipped with a stirrer, a thermometer, and a cooling tube, after adding distilled water 968 g, acrylic acid (54.00 g, 0.62 mol), ammonium persulfate (0.65 g, 2.85 mmol), 2-acrylamido-2-methylpropanesulfonic acid (6.00 g, 0.02 mol) and a 20% sodium hydroxide aqueous solution (0.8 equivalents based on a total amount of acrylic acid and 2-acrylamido-2-methylpropanesulfonic acid), an operation of reducing an internal pressure to 10 mmHg with diaphragm pump and returning the internal pressure to normal pressure with nitrogen, was repeated three times and then acrylonitrile (60.00 g, 0.94 mol) was added thereto.

The reaction was allowed to react for 18 hours while controlling the temperature of the reaction solution to be stable between 65° C. and 70° C. After adding ammonium persulfate (0.22 g, 0.95 mmol) for the second time, the temperature was raised to 80° C. and the reaction was conducted again for 4 hours. After cooling to ambient temperature, the pH of the reaction solution is adjusted to 7 to 8 using a 25% aqueous ammonia solution.

The poly(acrylic acid-co-acrylonitrile-co-sodium 2-acrylamido-2-methylpropanesulfonate salt) (glass transition temperature: −11° C.) was prepared in this manner. Herein, the mole ratio of the structural unit of acrylic acid, the structural unit of acrylamide, and the structural unit of 2-acrylamido-2-methylpropanesulfonic acid was 39:59:2. About 10 mL of the reaction solution (reaction product) was taken and the measurement result of the non-volatile component was 9.0% (theoretical value: 10%).

### (4) Preparation of Composition for Forming Adhesive Layer

As a PVdF 1-1 adhesive binder, poly(vinylidene-hexafluoropropylene) including a COOH functional group (P(VdF-HFP)) (a weight average molecular weight: 1,300,000g/mol, a mole ratio of PVdF:HFP=98:2, a glass transition temperature: −30° C., a melting point: 154° C., crystallinity: 39%) was prepared. 8 wt % of the PVdF 1-1 adhesive binder was added to acetone and then, stirred at 40° C. for 3 hours by using a stirrer to prepare a PVdF 1-1 adhesive binder solution.

As a PVdF 1-2 adhesive binder, poly(vinylidene-co-hexafluoropropylene) including no COOH functional group (P(VdF-co-HFP)) (a weight average molecular weight (Mw): 1,300,000 g/mol, a mole ratio of PVdF:HFP=98:2, a glass transition temperature: −30° C., a melting point: 151° C., crystallinity: 27%) was prepared. 8 wt % of the PVdF 1-2 adhesive binder was added to acetone and then, stirred at 40° C. for 3 hours by using a stirrer to prepare a PVdF 1-2 adhesive binder solution.

As a cyano group (—CN)-containing acrylic second adhesive binder, poly(acrylic acid-co-acrylonitrile-co-sodium 2-acrylamido-2-methylpropanesulfonate salt) (a weight average molecular weight (Mw): 1,400,000 g/mol) was prepared, as described above.

9 wt % of the cyano group (—CN)-containing acrylic second adhesive binder was added to NMP and then, stirred at 40° C. for 3 hours by using a stirrer to prepare a cyano group (—CN)-containing acrylic second adhesive binder solution.

The PVdF 1-1 adhesive binder, the PVdF 1-2 adhesive binder, and the second cyano group (—CN)-containing acrylic second adhesive binder were mixed in a weight ratio of 47.5:47.5:5 to prepare the adhesive binder solutions, and acetone was added thereto to prepare a composition for an adhesive layer with a total solid content of 5 wt %.

### (5) Manufacture of Separator

On both (e.g., two opposite) surfaces of a substrate, a heat resistant layer and an adhesive layer were sequentially formed.

A 7.0 μm-thick polyethylene film (PE, SK Innovation Co., Ltd.) was used as the substrate, the heat resistant layer (a thickness: 1.8 μm) was formed thereon by coating the composition for forming a heat resistant layer at 20 m/min in a direct metering method and drying it at 60° C. under an (average) absolute aqueous vapor amount of 14 g/m³.

In addition, on the heat resistant layer, the composition for forming an adhesive layer was coated at 20 m/min and dried at 60° C. under an (average) absolute aqueous vapor amount of 14 g/m³ to form an adhesive layer (a thickness: 0.8 μm).

In the same method as above, another heat resistant layer and another adhesive layer were sequentially formed on the other surface of the substrate.

### (6) Manufacture of Rechargeable Lithium Battery Cells

LiCoO₂ as a positive electrode active material, polyvinylidene fluoride as a binder, and carbon as a conductive material were mixed in a weight ratio of 92:4:4, and then, dispersed in N-methyl-2-pyrrolidone to prepare positive electrode slurry. The slurry was coated on a 20 μm-thick Al foil, dried, and compressed to manufacture a positive electrode.

Artificial graphite as a negative electrode active material, a styrene-butadiene rubber as a binder, and carboxylmethyl cellulose as a thickener in a weight ratio of 96:2:2 were dispersed in distilled water to prepare negative electrode active material slurry. The slurry was coated on a 15 μm-thick, dried, and compressed to manufacture a negative electrode.

A cylindrical battery cell was manufactured using the positive electrode, negative electrode, and separator. The electrolyte solution was a 1.3 M LiPF₆ solution in a mixed solvent of ethyl carbonate (EC)/ethylmethyl carbonate (EMC)/diethyl carbonate (DEC) (volume ratio of 3/5/2).

### Example 2

A separator and a rechargeable lithium battery cell were manufactured in the same manner as in Example 1 except that except that the weight ratio of the first inorganic particles to the second inorganic particles was changed to 3:97.

### Example 3

A separator and a rechargeable lithium battery cell were manufactured in the same manner as in Example 1 except that except that the weight ratio of the first inorganic particles to the second inorganic particles was changed to 10:90.

### Example 4

A separator and a rechargeable lithium battery cell were manufactured in the same manner as in Example 1 except that except that the weight ratio of the first inorganic particles to the second inorganic particles was changed to 20:80.

### Example 5

A separator and a rechargeable lithium battery cell were manufactured in the same manner as in Example 1 except that except that the weight ratio of the first inorganic particles to the second inorganic particles was changed to 25:75.

### Comparative Example 1

A separator and a rechargeable lithium battery cell were manufactured in the same manner as in Example 1 except that except that the weight ratio of the first inorganic particles to the second inorganic particles was changed to 0:100.

(In Comparative Example 1, the first inorganic particles were not included.)

### Comparative Example 2

A separator and a rechargeable lithium battery cell were manufactured in the same manner as in Example 1 except that except that the weight ratio of the first inorganic particles to the second inorganic particles was changed to 100:0.

(In Comparative Example 2, the second inorganic were not included.)

### Comparative Example 3

A separator and a rechargeable lithium battery cell were manufactured in the same manner as in Example 1 except that the PVdF 1-1 adhesive binder solution alone was used to prepare the composition for forming an adhesive layer (e.g., the PVdF 1-2 adhesive binder was omitted).

### Comparative Example 4

A separator and a rechargeable lithium battery cell were manufactured in the same manner as in Example 1 except that the PVdF 1-2 adhesive binder solution alone was used to prepare the composition for an adhesive layer (e.g., the PVdF 1-1 adhesive binder was omitted).

### Comparative Example 5

A separator and a rechargeable lithium battery cell were manufactured in the same manner as in Example 1 except that the cyano group (—CN)-containing acrylic second adhesive binder solution alone was used to prepare the composition for an adhesive layer.

Each separator of the Examples and Comparative Examples are summarized in Table 1.

TABLE 1

| | Heat resistant layer | | Adhesive layer |
|---|---|---|---|
| Ex. 1 | First inorganic | Total inorganic | PVdF 1-1 adhesive binder:PVdF 1- |
| | particles:second inorganic | particles:heat resistant | 2 adhesive binder:cyano group |
| | particles = 5:95 | binder = 95:5 | (—CN)-containing acrylic second |
| | | | adhesive binder = 47.5:47.5:5 |
| Ex. 2 | First inorganic | Total inorganic | PVdF 1-1 adhesive binder:PVdF 1- |
| | particles:second inorganic | particles:heat resistant | 2 adhesive binder:cyano group |
| | particles = 3:97 | binder = 95:5 | (—CN)-containing acrylic second |
| | | | adhesive binder = 47.5:47.5:5 |
| Ex. 3 | First inorganic | Total inorganic | PVdF 1-1 adhesive binder:PVdF 1- |
| | particles:second inorganic | particles:heat resistant | 2 adhesive binder:cyano group |
| | particles = 10:90 | binder = 95:5 | (—CN)-containing acrylic second |
| | | | adhesive binder = 47.5:47.5:5 |
| Ex. 4 | first inorganic | Total inorganic | PVdF 1-1 adhesive binder:PVdF 1- |
| | particles:second inorganic | particles:heat resistant | 2 adhesive binder:cyano group |
| | particles = 20:80 | binder = 95:5 | (—CN)-containing acrylic second |
| | | | adhesive binder = 47.5:47.5:5 |
| Ex. 5 | First inorganic | Total inorganic | PVdF 1-1 adhesive binder:PVdF 1- |
| | particles:second inorganic | particles:heat resistant | 2 adhesive binder:cyano group |
| | particles = 25:75 | binder = 95:5 | (—CN)-containing acrylic second |
| | | | adhesive binder = 47.5:47.5:5 |
| Comp. | First inorganic | Total inorganic | PVdF 1-1 adhesive binder:PVdF 1- |
| Ex. 1 | particles:second inorganic | particles:heat resistant | 2 adhesive binder:cyano group |
| | particles = 0:100 | binder = 95:5 | (—CN)-containing acrylic second |
| | | | adhesive binder = 47.5:47.5:5 |
| Comp. | First inorganic | Total inorganic | PVdF 1-1 adhesive binder:PVdF 1- |
| Ex. 2 | particles:second inorganic | particles:heat resistant | 2 adhesive binder:cyano group |
| | particles = 100:0 | binder = 95:5 | (—CN)-containing acrylic second |
| | | | adhesive binder = 47.5:47.5:5 |
| Comp. | First inorganic | Total inorganic | PVdF 1-1 adhesive binder |
| Ex. 3 | particles:second inorganic | particles:heat resistant | |
| | particles = 5:95 | binder = 95:5 | |
| Comp. | First inorganic | Total inorganic | PVdF 1-2 adhesive binder |
| Ex. 4 | particles:second inorganic | particles:heat resistant | |
| | particles = 5:95 | binder = 95:5 | |
| Comp. | First inorganic | Total inorganic | Cyano group (—CN)-containing |
| Ex. 5 | particles:second inorganic | particles:heat resistant | acrylic second adhesive binder |
| | particles = 5:95 | binder = 95:5 | |

### Evaluation Examples

### Evaluation Example 1: Separator

### (1) Air Permeability

Each of the separators according to the Examples and Comparative Examples was measured with respect to air permeability in the following method, and the results are shown in Table 2.

The air permeability is obtained by measuring time (seconds) taken for 100 cc of air to pass each of the separators by using an air permeability measuring device (EG01-55-1MR, Asahi Seiko Co., Ltd.).

### (2) Loading Amount and Coating Density of Heat Resistant Layer

For each separator of the Examples and Comparative Examples, the loading amount and coating density were measured in the following manner, and the results are listed in Table 2.

With the heat resistant layer alone formed on the cross-section of the substrate, it was cut to 10 cm (width)*10 cm (length), and then the weight of the substrate was subtracted to obtain the weight (loading amount) of the heat resistant layer alone. The coating density, which was the measured loading value divided by the coating thickness, is listed in Table 2.

### (3) Resistance

Each of the separators according to the Examples and Comparative Examples was measured with respect to resistance in the following method, and the results are shown in Table 2.

The resistance of the separators was measured through AC impedance.

### (4) Moisture Content

For each separator of the Examples and Comparative Examples, the moisture content was measured by the method, and the results are shown in Table 2.

The moisture content of the separator was measured according to the Karl-Fischer measurement method.

### (5) Adhesion

Each of the separators according to the Examples and Comparative Examples was measured with respect to adhesion between substrate and coating layer (heat resistant layer), adhesion between separator and positive electrode during drying, and adhesion between separator and positive electrode during wetting, and the results are shown in Table 3.

### Adhesion of Substrate-Coating Layer (Heat Resistant Layer)

After attaching each of the separators to a tape with a width of 10 mm and then, bending them at 180°, a force (N) required for tearing the tape off from the separator was measured by using a tension meter (HT400, Tinius Olsen Inc.).

### Separator-Positive Electrode Adherence when Drying

After attaching each of the separators to a positive electrode and then, bending them at 180°, a force (N) required for tearing the positive electrode off from the separator was measured by using a tension meter (HT400, Tinius Olsen Inc.).

Herein, the positive electrode was the same as described in Example 1.

### (6) Heat Resistance

Each of the separators according to the Examples and Comparative Examples was evaluated with respect to heat resistance in the following method, and the results are shown in Table 3.

Each of the separators was cut into a size of 10 cm×10 cm to prepare a sample. After drawing a quadrangle with a size of 5 cm×5 cm on the surface of the sample, the sample was inserted between papers or alumina powder, allowed to stand at 150° C. for 1 hour in an oven, and taken out therefrom to measure each size of sides of the quadrangle, which was used to calculate each shrinkage rate in a machine direction (MD) and a transverse direction (TD).

TABLE 2

| | Air | Loading amount | Coating density | | Moisture |
|---|---|---|---|---|---|
| | Permeability | of heat resistant | of heat resistant | Resistance | content |
| | (sec/100 cc) | layer (g/m²) | layer (L/L) | (Ω) | (ppm) |
| Ex. 1 | 165 | 2.23 | 1.22 | 0.64 | 1225 |
| Ex. 2 | 166 | 2.24 | 1.22 | 0.64 | 1273 |
| Ex. 3 | 167 | 2.25 | 1.23 | 0.65 | 1346 |
| Ex. 4 | 172 | 2.31 | 1.26 | 0.66 | 1586 |
| Ex. 5 | 180 | 2.32 | 1.28 | 0.66 | 1726 |
| Comp. Ex. 1 | 207 | 2.74 | 1.52 | 1.8 | 3500 |
| Comp. Ex. 2 | 163 | 2.2 | 1.2 | 0.63 | 1100 |
| Comp. Ex. 3 | 167 | 2.23 | 1.22 | 0.62 | 1233 |
| Comp. Ex. 4 | 166 | 2.24 | 1.22 | 0.60 | 1240 |
| Comp. Ex. 5 | 250 | 2.24 | 1.22 | 0.7 | 1237 |

TABLE 3

| | Adherence (N) | | | |
|---|---|---|---|---|
| | Substrate- | Separator- | Separator- | Shrinkage |
| | coating | positive | positive | rate |
| | layer | Electrode (Dry) | Electrode (wet) | (%, MD/TD) |
| Ex. 1 | 0.87 | 0.67 | 0.63 | 3/3 |
| Ex. 2 | 0.88 | 0.67 | 0.63 | 3/3 |
| Ex. 3 | 0.90 | 0.68 | 0.63 | 3/3 |
| Ex. 4 | 0.92 | 0.68 | 0.64 | 3/3 |
| Ex. 5 | 0.93 | 0.68 | 0.61 | 3/3 |
| Comp. Ex. 1 | 1.05 | 0.67 | 0.68 | 3/3 |
| Comp. Ex. 2 | 0.63 | 0.67 | 0.63 | 3/3 |
| Comp. Ex. 3 | 0.60 | 0.21 | 0.78 | 3/3 |
| Comp. Ex. 4 | 0.56 | 0.82 | 0.23 | 3/3 |
| Comp. Ex. 5 | 1.02 | 0.1 | 0.1 | 3/3 |

### Evaluation Example 2: Rechargeable Lithium Battery

### (1) Ambient Temperature Cycle-Life Characteristics

Each of the separators of the Examples and Comparative Examples was evaluated with respect to ambient temperature cycle-life characteristics in the following method, and the results are shown in Table 4.

The rechargeable lithium battery cells were constant current-charged to 4.25 V at a current rate of 1.0 C and constant voltage-charged to a current of 0.05 C, while maintaining 4.25 V, in an ambient temperature (25° C.) chamber and then, discharged to a voltage of 2.8 V at a constant current of 1.0 C.

This charge and discharge as one cycle were repeated 500 times to evaluate capacity retention according to Equation 1.

### (2) High Temperature Cycle-Life Characteristics

Each of the separators of the Examples and Comparative Examples was evaluated with respect to high temperature cycle-life characteristics in the following method, and the results are shown in Table 4.

The rechargeable lithium battery cells were constant current-charged to 4.25 V at a current rate of 1.0 C and constant voltage-charged to a current of 0.05 C, while maintaining 4.25 V, in a high temperature (45° C.) chamber and then, discharged to a voltage of 2.8 V at a constant current of 1.0 C.

This charge and discharge as one cycle were repeated 500 times to evaluate capacity retention according to Equation 1.

$$Capacity retention rate ( \% ) = ( discharge capacity at 500 th cycle / discharge capcity at first cycle ) \times 100 \qquad [ Equation 1 ]$$

TABLE 4

| | Ambient-temperature | High-temperature |
|---|---|---|
| | cycle-life (%) | cycle-life (%) |
| Ex. 1 | 93.2 | 88.7 |
| Ex. 2 | 93.3 | 88.6 |
| Ex. 3 | 93.2 | 88.6 |
| Ex. 5 | 93.2 | 88.4 |
| Comp. Ex. 1 | 91.3 | 84.7 |
| Comp. Ex. 2 | 92.9 | 88.1 |
| Comp. Ex. 3 | 91.5 | 84.3 |
| Comp. Ex. 4 | 91.8 | 83.4 |
| Comp. Ex. 5 | 85.1 | 75.2 |

### SUMMARY

Comprehensively considering Tables 1 to 4, the separators according to the Examples simultaneously secured heat resistance and adhesion and thus, may help improve cycle-life characteristics of the rechargeable lithium battery cells at ambient temperature and a high temperature.

In an implementation, a loading amount of the heat resistant layer may be the same, and the coating density of the heat resistant layer may be increased when two types of inorganic particles with different D50 particle sizes are used compared to the case where only one type of inorganic particle is used.

By way of summation and review, in an effort to help reduce or prevent short-circuits between the positive and negative electrodes in rechargeable lithium batteries, olefin substrates may be used as separators. The olefin substrate may have the advantage of excellent flexibility, but may exhibit rapid heat shrinkage at high temperatures of 100° C. or higher.

In order to address these issues, a method of forming an inorganic particle coating layer on at least one surface of the olefin substrate has been considered. Heat resistance and adhesion may be in a trade-off relationship. Accordingly, an inorganic particle coating layer may be formed on at least one surface of the olefin-sed substrate, heat resistance may be ensured, and adhesion may not be achieved.

One or more embodiments may provide a separator for a rechargeable lithium battery that simultaneously secures heat resistance and adhesion.

Example embodiments have been disclosed herein, and although specific terms are employed, they are used and are to be interpreted in a generic and descriptive sense only and not for purposes of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A separator for a rechargeable lithium battery, the separator comprising:
a substrate;
a heat resistant layer on the substrate; and
an adhesive layer on the heat resistant layer,
wherein:
the heat resistant layer includes:
two types of inorganic particles with different D50 particle diameters, and
a salt-based heat resistant binder, and
the adhesive layer includes:
a PVdF first adhesive binder, and
a cyano group (—CN)-containing acrylic second adhesive binder.

2. The separator as claimed in claim 1, wherein the two types of inorganic particles each independently include boehmite, silica (SiO₂), alumina (Al₂O₃), titania (TiO₂), clay, BaSO₄, MgO, Mg(OH)₂, or a combination thereof.

3. The separator as claimed in claim 1, wherein the two types of inorganic particles include:
first inorganic particles having a D50 particle diameter of greater than or equal to about 1 nm and less than about 200 nm; and
second inorganic particles having a D50 particle diameter of greater than or equal to about 200 nm and less than about 500 nm.

4. The separator as claimed in claim 1, wherein the salt-based heat resistant binder includes an acrylic salt-based binder including nitrogen (N).

5. The separator as claimed in claim 4, wherein the salt-based heat resistant binder includes:
a first structural unit including a structural unit of a (meth)acrylic acid or (meth)acrylate and a structural unit of a (meth)acrylamide; and
a second structural unit of a (meth)acrylamidosulfonic acid or a salt thereof.

6. The separator as claimed in claim 5, wherein:
the structural unit of a (meth)acrylic acid or (meth)acrylate is represented by Chemical Formula 1, Chemical Formula 2, Chemical Formula 3, or a combination thereof,
the structural unit of a (meth)acrylamide is represented by Chemical Formula 4, and
the second structural unit of a (meth)acrylamidosulfonic acid or a salt thereof is represented by Chemical Formula 5, Chemical Formula 6, Chemical Formula 7, or a combination thereof: 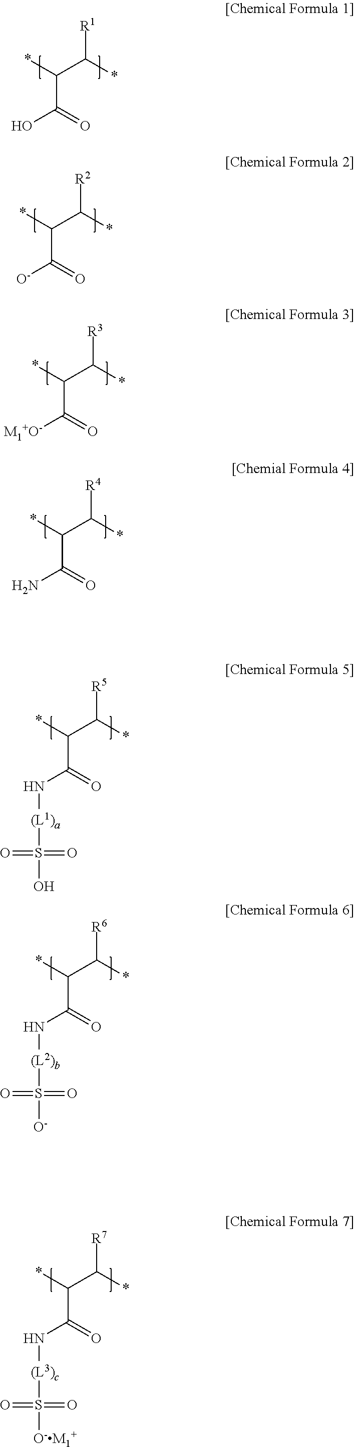
in Chemical Formulas 1 to 7,
R¹ to R⁷ are each independently hydrogen or substituted or unsubstituted C1 to C6 alkyl group;
L¹ to L³ are each independently a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group;
M₁ is an alkali metal; and
a, b, and c are each independently an integer of 0 to 2.

7. The separator as claimed in claim 6, wherein the salt-based heat resistant binder includes poly(acrylic acid-co-acrylamide-co-sodium 2-acrylamido-2-methylpropanesulfonate salt).

8. The separator as claimed in claim 1, wherein the heat resistant layer further includes a swellable binder with a core-shell structure.

9. The separator as claimed in claim 1, wherein the heat resistant layer includes:
about 70 to about 99 wt % of the two types of inorganic particles entire, and
about 1 to about 30 wt % of the heat resistant binder, all wt % being based on a total weight of the heat resistant layer.

10. The separator as claimed in claim 1, wherein the PVdF first adhesive binder includes poly(vinylidene-hexafluoropropylene) (P(VdF-HFP)) including a COOH functional group.

11. The separator as claimed in claim 10, wherein the poly(vinylidene-hexafluoropropylene) (P(VdF-HFP)) including a COOH functional group has a crystallinity of about 35 to about 50%.

12. The separator as claimed in claim 10, wherein the PVdF first adhesive binder further includes poly(vinylidene-co-hexafluoropropylene) (P(VdF-co-HFP)) not including a COOH functional group.

13. The separator as claimed in claim 12, wherein the poly(vinylidene-co-hexafluoropropylene) (P(VdF-co-HFP)) not including a COOH functional group has a crystallinity of 10 to 30%.

14. The separator as claimed in claim 12, wherein a weight ratio of the poly(vinylidene-hexafluoropropylene) (P(VdF-HFP)) including a COOH functional group and the poly(vinylidene-co-hexafluoropropylene) (P(VdF-co-HFP)) not including a COOH functional group is about 1:99 to about 99:1.

15. The separator as claimed in claim 1, wherein the cyano group (—CN)-containing acrylic second adhesive binder includes:
a third structural unit of a (meth)acrylic acid or (meth)acrylate;
a fourth cyano group-containing structural unit; and
a fifth structural unit of a (meth)acrylamidosulfonic acid or a salt thereof.

16. The separator as claimed in claim 15, wherein:
the third structural unit of a (meth)acrylic acid or (meth)acrylate is represented by Chemical Formula 11, Chemical Formula 12, Chemical Formula 13, or a combination thereof,
the fourth cyano group-containing structural unit is represented by Chemical Formula 14, and
the fifth structural unit of a (meth)acrylamidosulfonic acid or the salt thereof is represented by Chemical Formula 15, Chemical Formula 16, Chemical Formula 17, or a combination thereof: 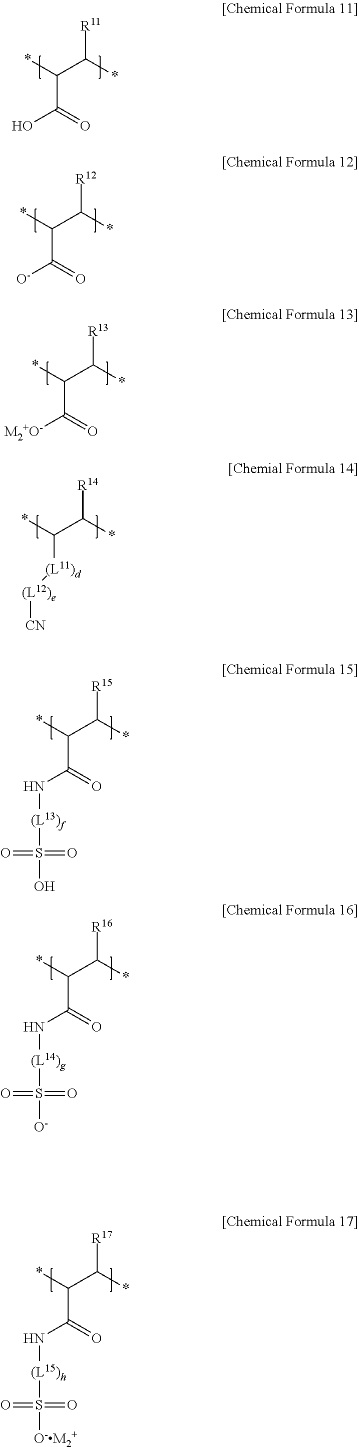
in Chemical Formulae 11 to 17,
R¹¹ to R¹⁷ are each independently hydrogen or a substituted or unsubstituted C1 to C6 alkyl group;
L¹¹ and L¹² are each independently a single bond, a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group;
L¹³ to L¹⁵ are each independently a substituted or unsubstituted Cl to C10 alkylene group, a substituted or unsubstituted C3 to C20 cycloalkylene group, a substituted or unsubstituted C6 to C20 arylene group, or a substituted or unsubstituted C3 to C20 heterocyclic group;
M₂ is an alkali metal; and
d, e, f, g, and h are each independently an integer of 0 to 2.

17. The separator as claimed in claim 16, wherein the cyano group (—CN)-containing acrylic second adhesive binder includes poly(acrylic acid-co-acrylonitrile-co-sodium 2-acrylamido-2-methylpropanesulfonate salt).

18. The separator as claimed in claim 1, wherein the adhesive layer includes:
about 70 to about 99 wt % of the PVdF first adhesive binder, and
about 1 to about 30 wt % of the cyano group (—CN)-containing acrylic second adhesive binder, all wt % being based on the total amount of the adhesive layer.

19. The separator as claimed in claim 1, wherein the heat resistant layer and the adhesive layer are respectively on two opposite surfaces of the substrate.

20. A rechargeable lithium battery, comprising:
a positive electrode;
a negative electrode; and
the separator as claimed in claim 1 between the positive electrode and the negative electrode.
